(19) United States
(12) Patent Application Publication
(10) Pub. No.: US 2026/0127090 A1
(43) Pub. Date: May 7, 2026

(54) INTELLIGENT TRACKING SYSTEM AND OPERATION METHOD THEREOF

(71) Applicant: Quanta Computer Inc., Taoyuan City (TW)

(72) Inventors: Chen-Chung LEE, Taoyuan City (TW); Chu-Chun CHANG, Taoyuan City (TW); Chia-Hung LIN, Taoyuan City (TW); Kun-Ping KUO, Taoyuan City (TW)

(21) Appl. No.: 19/001,144

(22) Filed: Dec. 24, 2024

(30) Foreign Application Priority Data
Nov. 5, 2024 (TW) 113142289

(51) Int. Cl. G06F 11/34; G06F 11/30; G06F 16/22

(52) U.S. Cl. CPC G06F 11/3476; G06F 11/302; G06F 16/22

(57) ABSTRACT

An intelligent tracking system includes a processor and a storage device. The processor is used to access a service content analysis module, a remote sensing payload analysis module, a span module, and a remote sensing storage module to execute the service content analysis module, the remote sensing payload analysis module, the span module, and the remote sensing storage module. The processor executes the following operations. The service content analysis module analyzes service data to obtain a general content and a remote sensing payload. The remote sensing payload analysis module analyzes the remote sensing payload to obtain customized data. The span module adds at least one log to the service data to generate span data. The remote sensing storage module stores the span data, the general content, the remote sensing payload, and the customized data in a database to form tracking data.

### CROSS REFERENCE TO RELATED APPLICATIONS

This application claims priority of Taiwan Patent Application No. 113142289, filed on Nov. 5, 2024, the entirety of which is incorporated by reference herein.

### BACKGROUND OF THE INVENTION

### Field of the Invention

The present invention relates to a tracking system, and in particular it relates to an intelligent tracking system and an operation method thereof.

### Description of the Related Art

With the rapid increase in the number of application systems, remote sensing systems have become an indispensable part of modern software development and operation. Remote sensing systems are responsible for data collection and monitoring. Through the “tracking mechanism” of a remote sensing system, developers and operation teams may monitor the flow, the errors, and various other key indicators of applications in real time to ensure the reliable operation of the system. Its rich data and insights help us monitor various applications in different environments.

However, since the remote sensing systems on the market need to be able to support the tracking of customized data, system specifications need to be changed to transmit and record the customized data, and there is also a lack of automation. Therefore, how to simultaneously have information that includes the tracking data and the customized data without changing the system specifications has become a focus for technical improvements by various manufacturers.

### BRIEF SUMMARY OF THE INVENTION

An embodiment of the present invention provides an intelligent tracking system and an operation method thereof, so that the intelligent tracking system may simultaneously have information that includes the tracking data and the customized data without changing the system specifications, so as to increase the convenience of use.

An embodiment of the present invention provides an intelligent tracking system, which includes a processor and a storage device. The processor is used to access a service content analysis module, a remote sensing payload analysis module, a span module, and a remote sensing storage module stored in the storage device to execute the service content analysis module, the remote sensing payload analysis module, the span module, and the remote sensing storage module. The processor executes the following operations. The service content analysis module is used to analyze service data to obtain a general content and a remote sensing payload. The remote sensing payload analysis module is used to analyze the remote sensing payload to obtain customized data. The span module is used to add at least one log to the service data to generate span data. The remote sensing storage module is used to store the span data, the general content, the remote sensing payload, and the customized data in a database to form tracking data.

An embodiment of the present invention provides an operation method of an intelligent tracking system, which includes the following steps. A service content analysis module is used to analyze service data to obtain a general content and a remote sensing payload. A remote sensing payload analysis module is used to analyze the remote sensing payload to obtain customized data. A span module is used to add at least one log to the service data to generate span data. A remote sensing storage module is used to store the span data, the general content, the remote sensing payload, and the customized data in a database to form tracking data.

According to the intelligent tracking system and the operation method thereof disclosed by the present invention, the service content analysis module analyzes the service data to obtain the general content and the remote sensing payload. The remote sensing payload analysis module analyzes the remote sensing payload to obtain the customized data. The span module adds the log to the service data to generate the span data. The remote sensing storage module stores the span data, the general content, the remote sensing payload, and the customized data in the database to form the tracking data. Therefore, the intelligent tracking system may simultaneously have information that includes the tracking data and the customized data without changing the system specifications, so as to increase the convenience of use.

### BRIEF DESCRIPTION OF THE DRAWINGS

The present invention can be more fully understood by reading the subsequent detailed description and examples with references made to the accompanying drawings, wherein:

FIG. 1 is a schematic view of an intelligent tracking system according to an embodiment of the present invention;

FIG. 2 is a schematic view of an intelligent tracking system according to another embodiment of the present invention;

FIG. 3 is a flowchart of an operation method of an intelligent tracking system according to an embodiment of the present invention;

FIG. 4 is a flowchart of an operation method of an intelligent tracking system according to another embodiment of the present invention;

FIG. 5 is a detailed flowchart of step S304 in FIG. 3 or FIG. 4; and

FIG. 6 is a detailed flowchart of step S404 in FIG. 4.

### DETAILED DESCRIPTION OF THE INVENTION

In each of the following embodiments, the same reference number represents an element or component that is the same or similar.

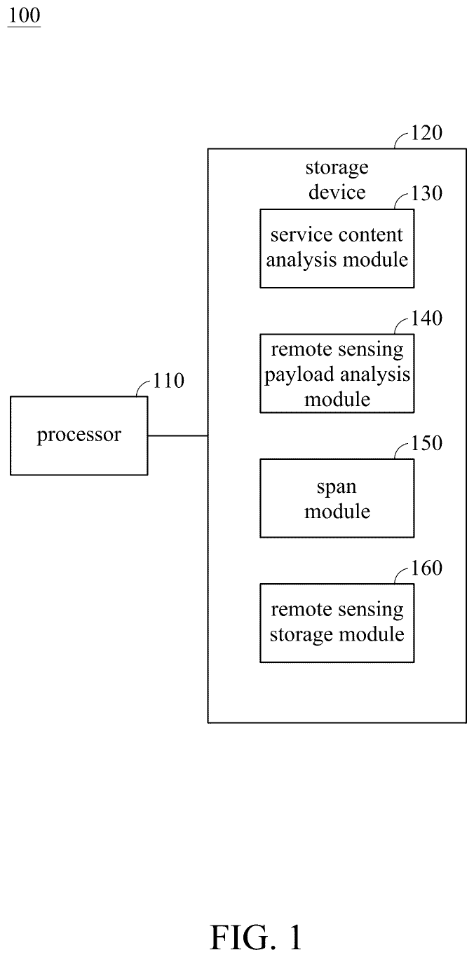

FIG. 1 is a schematic view of an intelligent tracking system according to an embodiment of the present invention. Please refer to FIG. 1. The intelligent tracking system 100 may include a processor 110 and a storage device 120. In some embodiments, the intelligent tracking system 100 may be a server, a notebook computer, a desktop computer, a smart monitor, a smart monitoring device, or an electronic device with computing and storage functions.

The processor 110 may be coupled to the storage device 120. The processor 110 may be used to access a program stored in the storage device 120 to execute the functions of a service content analysis module 130, a remote sensing payload analysis module 140, a span module 150 and a remote sensing storage module 160.

In some embodiments, the processor 110 may include a micro control unit (MCU), a microprocessor, a digital signal processor (DSP), a field programmable gate array (FPGA), an application specific integrated circuit (ASIC) or a logic circuit, but the embodiment of the present invention is not limited thereto.

In some embodiments, the storage device 120 may include a read-only memory (ROM), a flash memory, a floppy disk, a hard disk, an optical disk, a flash drive, a tape, or another suitable storage medium, but the embodiment of the present invention is not limited thereto. In some embodiments, the service content analysis module 130, the remote sensing payload analysis module 140, the span module 150 and the remote sensing storage module 160 may be implemented by software. In some embodiments, the service content analysis module 130, the remote sensing payload analysis module 140, the span module 150 and the remote sensing storage module 160 may be implemented by hardware circuits or chips with specific functions that are independent of the storage device 120.

The processor 110 may use the service content analysis module 130 to analyze service data to obtain a general content and a remote sensing payload. For example, when the processor 110 receives that a downstream service is called from an upstream service (such as an external service), the processor 110 may immediately start the intelligent tracking mechanism. Then, the processor 110 may use the service content analysis module 130 to analyze the service content provided by the downstream service to obtain the general content and the remote sensing payload. Specifically, the processor 110 may use the service content analysis module 130 to completely record the service content provided by the downstream service.

In the embodiment, the above remote sensing payload may include data such as a trace identifier (Trace ID) used to connect traces of the upstream and downstream services, and the general content may include a transmission protocol used by the downstream service and the input parameters received when the downstream service is triggered, etc., but the embodiment of the present invention is not limited thereto.

In addition, the transmission protocol may be a hypertext transfer protocol (http) or a hypertext transfer protocol secure (https), but the embodiment of the present invention is not limited thereto. Furthermore, the above downstream service may be a representational state transfer (RESTful) application programming interface (API), and the above input parameters may be data related to the hypertext transfer protocol request (http request)/the hypertext transfer protocol response (http response), but the embodiment of the present invention is not limited thereto.

Then, the processor 110 may use the remote sensing payload analysis module 140 to analyze the remote sensing payload to obtain customized data. For example, the remote sensing payload analysis module 140 may split out the customized data that has been added to the original data according to pre-designed customized specification, and the recording manner is stored in a “key:value” format. In addition, in order to ensure that the customized data does not affect other data, the naming of “key” may be designed in a unique and unmodifiable way. Furthermore, each “key:value” may represent one customized data. In addition, if multiple sets of customized data are needed in the original data, it needs to design multiple sets of different “key:value” to transmit them. Therefore, the customized data may be attached to the original data, so as to decrease the threshold for each system to read and write data through the intelligent tracking system 100, and each application system does also not need to change its own system architecture.

In some embodiments, the above customized data may include a device identifier (AqDeviceId), a platform call skill service serial number identifier (AqSequence), a session identifier (AqSessionId), a skill self-use identifier (AqSaasEventId) and a user identifier (CampUserId), etc., but the embodiment of the present invention is not limited thereto. In other embodiments, the user may adjust the content of customized data according to the requirements thereof, i.e., in addition to the above identifiers, the customized data may also include other suitable identifiers.

For example, the downstream services itself is a skill application interface API, which may only be called by the external platform, and the platform is also triggered by the session generated by the front-end user (CampUser). Therefore, it is generally impossible for the downstream service to obtain the session identifier (AqSessionId) and the user identifier (CampUserId). Through the assistance of the remote sensing payload analysis module 140 in the embodiment of the present invention, the purpose of automatically transmitting and recording customized data may be achieved.

Furthermore, in some embodiments, when the processor 110 receives the general content and the remote sensing payload provided by the service content analysis module 130, the processor 110 may use the remote sensing payload analysis module 140 to determine whether to analyze the remote sensing payload according to an intelligent tracking setting value. Specifically, the remote sensing payload analysis module 140 determines whether to disassemble the complete data transmitted by the service content analysis module according to the pre-designed customized specifications according to the intelligent tracking setting value, so as to subsequently read the customized data. In some embodiments, when the intelligent tracking setting value is set to “Y”, this means that the analysis function of the remote sensing payload analysis module 140 is to be enabled. When the intelligent tracking setting value is set to “N”, this means that the analysis function of the remote sensing payload analysis module 140 is not to be enabled.

When determining not to analyze the remote sensing payload (for example, the intelligent tracking setting value is set to “N”), the processor 110 may use the remote sensing payload analysis module 140 to store the general content and the remote sensing payload. When determining to analyze the remote sensing payload (for example, the intelligent tracking setting value is set to “Y”), the processor 110 may use the remote sensing payload analysis module 140 to analyze the remote sensing payload to obtain the customized data and to store the customized data, the general content, and the remote sensing payload.

Afterward, the processor 110 may use the span module 150 to add at least one log to the service data to generate span data. In some embodiments, the downstream service itself is a representational state transfer application programming interface (RESTful API), and when the processor 110 executes the service content analysis module 130, the service content analysis module 130 may only record information related to the hypertext transfer protocol operations. Through the span module 150 of the embodiment of the present invention, the log is added to the service data, so that the service content may record more other information, such as the application, the application name, the application version number, etc. represented by the downstream service.

Specifically, information other than the service content analysis module 130 may be added by the span module 150 to increase the richness of the span of the service content and allow the intelligent tracking system 100 to record more logs of different field information. Furthermore, the span module 150 may also use the customized data successfully read and stored through the remote sensing payload analysis module 140 to update the field information of the span of the service content, so as to achieve the purpose for successfully adopting the customized data transmitted from the outside.

Afterward, the processor 110 may use the remote sensing storage module 160 to store the span data, the general content, the remote sensing payload, and the customized data in a database to form tracking data. In some embodiments, the database is, for example, a database of a “elasticsearch” platform, and the transmission of stored data to the database uses, for example, the RabbitMQ technology supported by the event bus, so that the data on the queue may be written sequentially to “elasticsearch” platform, so as to avoid the situation where excessive data volume may overwhelm the recording module, but the embodiment of the present invention is not limited thereto. Therefore, the intelligent tracking system 100 may complete the task of recording the tracking data, and simultaneously has information that includes the tracking data and the customized data without changing the system specifications.

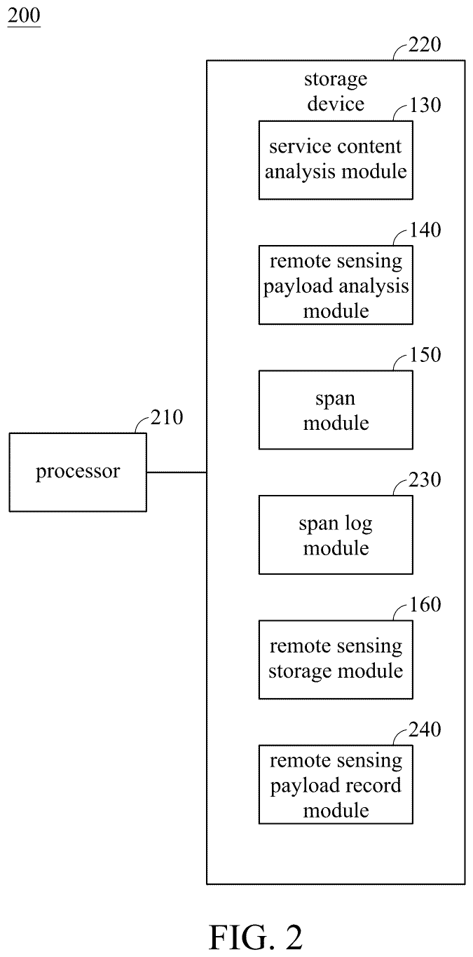

FIG. 2 is a schematic view of an intelligent tracking system according to another embodiment of the present invention. Please refer to FIG. 2. The intelligent tracking system 200 may include a processor 210 and a storage device 220. In some embodiments, the intelligent tracking system 200 may be a server, a notebook computer, a desktop computer, a smart monitor, a smart monitoring device, or an electronic device with computing and storage functions.

The processor 210 may be coupled to the storage device 220. The processor 210 may be used to access a program stored in the storage device 220 to execute the functions of a service content analysis module 130, a remote sensing payload analysis module 140, a span module 150, a remote sensing storage module 160, a span log module 230 and a remote sensing payload record module 240. In some embodiments, the processor 210 may include a micro control unit, a microprocessor, a digital signal processor, a field programmable gate array, an application specific integrated circuit or a logic circuit, but the embodiment of the present invention is not limited thereto.

In some embodiments, the storage device 220 may include a read-only memory (ROM), a flash memory, a floppy disk, a hard disk, an optical disk, a flash drive, a tape, or another suitable storage medium, but the embodiment of the present invention is not limited thereto. In some embodiments, the service content analysis module 130, the remote sensing payload analysis module 140, the span module 150, the remote sensing storage module 160 a span log module 230 and a remote sensing payload record module 240 may be implemented by software. In some embodiments, the service content analysis module 130, the remote sensing payload analysis module 140, the span module 150, the remote sensing storage module 160 a span log module 230 and a remote sensing payload record module 240 may be implemented by hardware circuits or chips with specific functions that are independent of the storage device 220.

In the embodiment, the service content analysis module 130, the remote sensing payload analysis module 140, the span module 150 and the remote sensing storage module 160 in FIG. 2 are the same as or similar to the service content analysis module 130, the remote sensing payload analysis module 140, the span module 150 and the remote sensing storage module 160 in FIG. 1. Accordingly, the service content analysis module 130, the remote sensing payload analysis module 140, the span module 150 and the remote sensing storage module 160 in FIG. 2 may refer to the description of the embodiment of FIG. 1, and the description thereof is not repeated herein.

The processor 210 may use the span log module 230 to add an event log within a span to the span data. Specifically, after the span module 150 generates the span data, the processor 210 may use the span log module 230 to add the event log of one or more single timestamps recorded in the timeline spanned by the span, i.e., the conditions of various different attributes that occur in a single time span, so as to break through the limitation that each attribute in the span module 150 may only record one-time value. In addition, the above event log may store data in an array manner to record an unlimited number of logs from 1 to N, and each event log may contain multiple fields to record information, but the embodiment of the present invention is not limited thereto.

The processor 210 may use the remote sensing payload record module 240 to share the tracking data. In some embodiments, the remote sensing payload record module 240 may use the same technology as the remote sensing payload analysis module 140. For example, taking the current supported representational state transfer application programming interface (RESTful API) as an example, the remote sensing payload record module 240 may store the customized data packaged with “key: value” through the hypertext transfer protocol header files (http headers) to share the tracking data to the downstream service, so that the downstream service may access the tracking data through the original application programming interface (API) technology without having to adjust the original docking method when called. Therefore, old systems that are already running online may be used without changing the system specifications, effectively increasing the development speed and significantly reducing the cost of introduction.

Furthermore, in some embodiments, when the processor 210 received the tracking data provided by the remote sensing storage module 160, the processor 210 may use the remote sensing payload record module 240 to determine whether to share the tracking data according to a sharing setting value. In some embodiments, when the sharing setting value is set to “Y”, this means that the data sharing function of the remote sensing payload record module 240 is to be enabled. When the sharing setting value is set to “N”, this means that that the data sharing function of the remote sensing payload record module 240 is not to be enabled.

When determining not to share the tracking data (for example, the sharing setting value is set as “N”), the processor 210 may not use the remote sensing payload record module 240 to share the tracking data. When determining to share the tracking data (for example, the sharing setting value is set as “Y”), the processor 210 may determine whether to share the customized data in the tracking data.

When determining not to share the customized data in the tracking data, the processor 210 may provide the span data, the general content, and the remote sensing payload in the tracking data. Specifically, the remote sensing payload record module 240 may read the tracking data (i.e., the span data, the general content, and the remote sensing payload), and then set it to the original call content. For example, the upstream service calls the representational state transfer application programming interface (RESTful API) of the downstream service, the remote sensing payload record module 240 may bring information such as trace identifier (Trace ID) of the remote sensing content of the tracking data into the hypertext transfer protocol header files (http headers), and allow them to be automatically transmitted when the request is issued.

When determining to share the customized data in the tracking data, the processor 210 may provide the span data, the general content, the remote sensing payload, and the customized data in the tracking data. That is the remote sensing payload record module 240 may read the tracking data (i.e., the span data, the general content, the remote sensing payload, and the customized data), and then set it to the original call content. For example, the upstream service calls the representational state transfer application programming interface of the downstream service, the remote sensing payload record module 240 may bring information such as trace identifier (Trace ID) of the remote sensing content and the customized data of the tracking data into the hypertext transfer protocol header files, and allow them to be automatically transmitted when the request is issued. Then, the original operation of calling the downstream service may be continued, and all customized information may be captured by the remote sensing content analysis module 140 again in the next cycle. Therefore, the intelligent tracking system 200 may achieve the effect of dynamically and automatically transmitting customized data without modifying the specification (Spec) of the representational state transfer application programming interface.

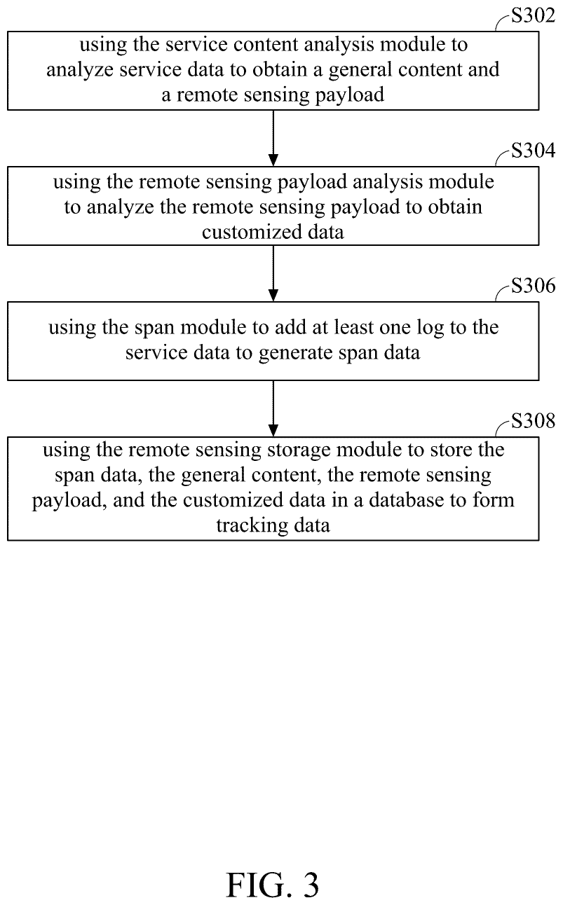

FIG. 3 is a flowchart of an operation method of an intelligent tracking system according to an embodiment of the present invention. In the embodiment, the operation method of the intelligent tracking system may be applied to the intelligent tracking system 100 in FIG. 1. In step S302, the method involves using the service content analysis module to analyze service data to obtain a general content and a remote sensing payload.

In step S304, the method involves using the remote sensing payload analysis module to analyze the remote sensing payload to obtain customized data. In step S306, the method involves using the span module to add at least one log to the service data to generate span data. In step S308, the method involves using the remote sensing storage module to store the span data, the general content, the remote sensing payload, and the customized data in a database to form tracking data.

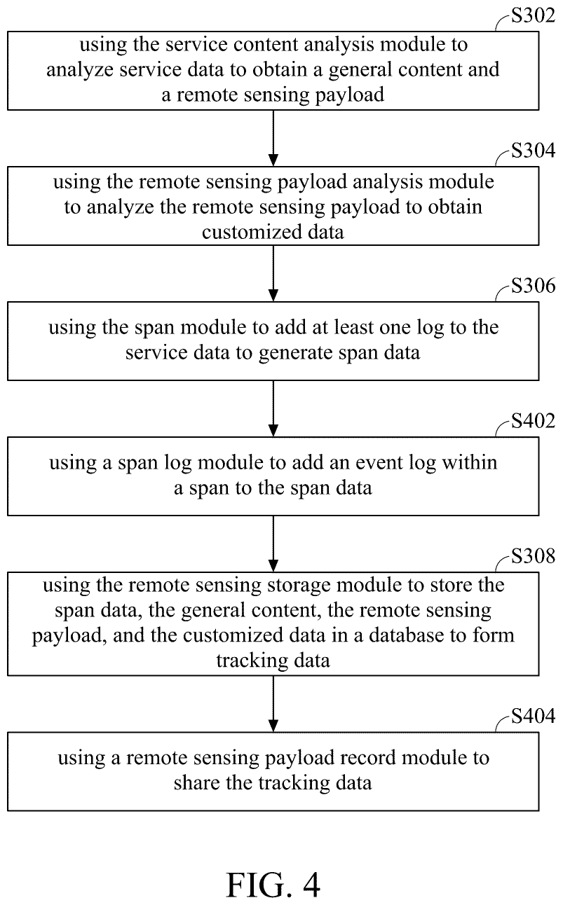

FIG. 4 is a flowchart of an operation method of an intelligent tracking system according to another embodiment of the present invention. In the embodiment, the operation method of the intelligent tracking system may be applied to the intelligent tracking system 200 in FIG. 2. In addition, in the embodiment, steps S302˜S308 in FIG. 4 are the same as or similar to steps S302˜308 in FIG. 3. Accordingly, steps S302˜308 in FIG. 4 may refer to the description of the embodiment of FIG. 3, and the description thereof is not limited thereto.

In step S402, the method involves using a span log module to add an event log within a span to the span data. In step S404, the method involves using a remote sensing payload record module to share the tracking data.

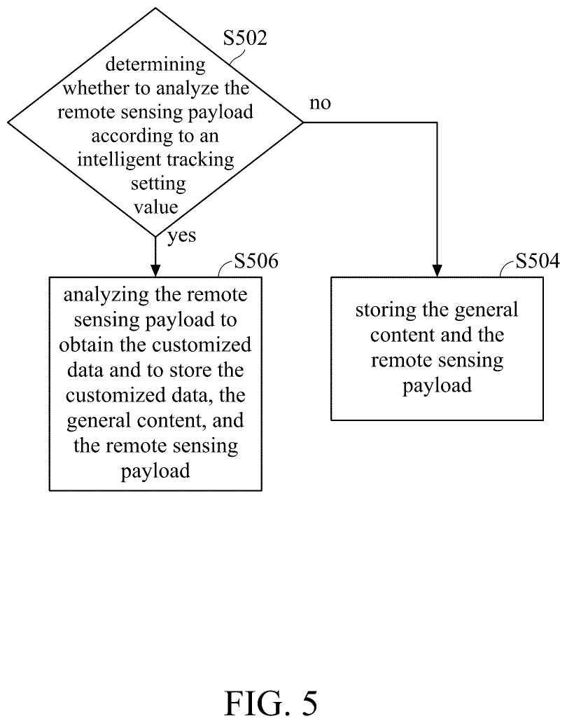

FIG. 5 is a detailed flowchart of step S304 in FIG. 3 or FIG. 4. In step S502, the method involves determining whether to analyze the remote sensing payload according to an intelligent tracking setting value. When determining not to analyze the remote sensing payload, the method performs step S504. In step S504, the method involves storing the general content and the remote sensing payload. When determining to analyze the remote sensing payload, the method performs step S506. In step S506, the method involves analyzing the remote sensing payload to obtain the customized data and to store the customized data, the general content, and the remote sensing payload.

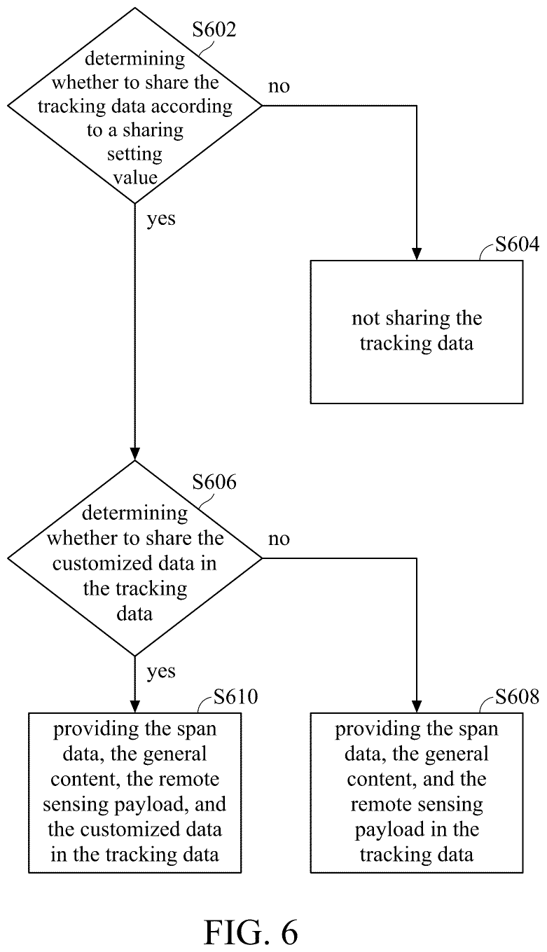

FIG. 6 is a detailed flowchart of step S404 in FIG. 4. In step S602, the method involves determining whether to share the tracking data according to a sharing setting value. When determining not to share the tracking data, the method performs step S604. In step S604, the method involves not sharing the tracking data. When determining to share the tracking data, the method performs step S606. In step S606, the method involves determining whether to share the customized data in the tracking data.

When determining not to share the customized data in the tracking data, the method performs step S608. In step S608, the method involves providing the span data, the general content, and the remote sensing payload in the tracking data. When determining to share the customized data in the tracking data, the method performs step S610. In step S610, the method involves providing the span data, the general content, the remote sensing payload, and the customized data in the tracking data.

In summary, according to the intelligent tracking system and the operation method thereof disclosed by the embodiment of the present invention, the service content analysis module analyzes the service data to obtain the general content and the remote sensing payload. The remote sensing payload analysis module analyzes the remote sensing payload to obtain the customized data. The span module adds the log to the service data to generate the span data. The remote sensing storage module stores the span data, the general content, the remote sensing payload, and the customized data in the database to form the tracking data. Therefore, the intelligent tracking system may simultaneously have information that includes the tracking data and the customized data without changing the system specifications, so as to increase the convenience of use. In addition, the intelligent tracking system of the embodiment of the present invention further include the span log module to add the event log within the span to the span data and the remote sensing payload record module to share the tracking data. Therefore, the richness of the span data may be increased, the intelligent tracking system may achieve the effect of dynamically and automatically transmitting customized data without modifying the specification of the representational state transfer application programming interface, and the intelligent tracking system may be used without changing the system specifications, the development speed may be effectively increased and the cost of introduction may be significantly reduced.

While the present invention has been described by way of example and in terms of the preferred embodiments, it should be understood that the present invention is not limited to the disclosed embodiments. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An intelligent tracking system, comprising:
a processor; and
a storage device, wherein the processor is used to access a service content analysis module, a remote sensing payload analysis module, a span module, and a remote sensing storage module stored in the storage device to execute the service content analysis module, the remote sensing payload analysis module, the span module, and the remote sensing storage module, and the processor executes:
using the service content analysis module to analyze service data to obtain a general content and a remote sensing payload;
using the remote sensing payload analysis module to analyze the remote sensing payload to obtain customized data;
using the span module to add at least one log to the service data to generate span data; and
using the remote sensing storage module to store the span data, the general content, the remote sensing payload, and the customized data in a database to form tracking data.

2. The intelligent tracking system as claimed in claim 1, wherein the storage device further comprises a span log module, and the processor further executes:
using the span log module to add an event log within a span to the span data.

3. The intelligent tracking system as claimed in claim 1, wherein the storage device further comprises a remote sensing payload record module, and the processor further executes:
using the remote sensing payload record module to share the tracking data.

4. The intelligent tracking system as claimed in claim 3, wherein the processor uses the remote sensing payload record module to determine whether to share the tracking data, when determining to share the tracking data, the processor determines whether to share the customized data in the tracking data, when determining not to share the customized data in the tracking data, the processor provides the span data, the general content, and the remote sensing payload in the tracking data, and when determining to share the customized data in the tracking data, the processor provides the span data, the general content, the remote sensing payload, and the customized data in the tracking data.

5. The intelligent tracking system as claimed in claim 1, wherein the processor uses the remote sensing payload analysis module to determine whether to analyze the remote sensing payload according to an intelligent tracking setting value, when determining not to analyze the remote sensing payload, the processor stores the general content and the remote sensing payload, and when determining to analyze the remote sensing payload, the processor analyzes the remote sensing payload to obtain the customized data and to store the customized data, the general content, and the remote sensing payload.

6. An operation method of an intelligent tracking system, comprising:
using a service content analysis module to analyze service data to obtain a general content and a remote sensing payload;
using a remote sensing payload analysis module to analyze the remote sensing payload to obtain customized data;
using a span module to add at least one log to the service data to generate span data; and
using a remote sensing storage module to store the span data, the general content, the remote sensing payload, and the customized data in a database to form tracking data.

7. The operation method of the intelligent tracking system as claimed in claim 6, further comprising:
using a span log module to add an event log within a span to the span data.

8. The operation method of the intelligent tracking system as claimed in claim 6, further comprising:
using a remote sensing payload record module to share the tracking data.

9. The operation method of the intelligent tracking system as claimed in claim 8, wherein the step of using the remote sensing payload record module to share the tracking data comprises:
determining whether to share the tracking data according to a sharing setting value;
when determining to share the tracking data, determining whether to share the customized data in the tracking data;
when determining not to share the customized data in the tracking data, providing the span data, the general content, and the remote sensing payload in the tracking data; and
when determining to share the customized data in the tracking data, providing the span data, the general content, the remote sensing payload, and the customized data in the tracking data.

10. The operation method of the intelligent tracking system as claimed in claim 6, wherein the step of using the remote sensing payload analysis module to analyze the remote sensing payload to obtain the customized data comprises:
determining whether to analyze the remote sensing payload according to an intelligent tracking setting value;
when determining not to analyze the remote sensing payload, storing the general content and the remote sensing payload; and
when determining to analyze the remote sensing payload, analyzing the remote sensing payload to obtain the customized data and to store the customized data, the general content, and the remote sensing payload.
